(19) United States
(12) Patent Application Publication
(10) Pub. No.: US 2023/0044822 A1
(43) Pub. Date: Feb. 9, 2023

(54) CYPHER SYSTEM, ENCRYPTION METHOD, DECRYPTION METHOD AND PROGRAM

(71) Applicant: NIPPON TELEGRAPH AND TELEPHONE CORPORATION, Tokyo (JP)

(72) Inventor: Akinori HOSOYAMADA, Tokyo (JP)

(73) Assignee: NIPPON TELEGRAPH AND TELEPHONE CORPORATION, Tokyo (JP)

(21) Appl. No.: 17/793,880

(22) PCT Filed: Jan. 28, 2020
(86) PCT No.: PCT/JP2020/003041

§ 371 Date: Jul. 19, 2022

(51) Int. Cl. H04L 9/08; H04L 9/06; H04L 9/14

(52) U.S. Cl. CPC H04L 9/0825; H04L 9/0618; H04L 9/14

(57) ABSTRACT

A cryptographic system includes an encryption apparatus including a memory and a processor configured to encrypt a plaintext into a ciphertext. The processor of the encryption apparatus executes generating first information resulting from encryption of the plaintext by an encryption function of a predetermined block cipher using a first secret key; generating second information resulting from encryption of a preset adjustment value by the encryption function using a second secret key; and generating the ciphertext by encrypting an arithmetic operation result of a bitwise exclusive OR of the first information and the second information by the encryption function using the first secret key.

### TECHNICAL FIELD

The present invention relates to a cryptographic system, an encryption method, a decryption method and a program.

### BACKGROUND ART

It has widely been known that cryptography is effective for confidentiality and authenticity of data. Examples of cryptography include, e.g., public key cryptosystem such as RSA (Rivest-Shamir-Adleman) and symmetric-key cryptosystem such as AES (Advanced Encryption Standard). While public key cryptosystems having the advantage of easy handling of a key, symmetric-key cryptosystems are generally advantageous from the perspective of processing speed. Therefore, symmetric-key cryptosystems are often used for, e.g., confidentiality and tamper detection of a large amount of data.

As one of secret-key ciphers, a secret-key block cipher (or simply called “block cipher”) has been known. Also, as a mechanism for encryption of a message that is longer than a block length via a secret-key block cipher, a block cipher mode of operation has been known. Use of a block cipher mode of operation enables addition of functions such as multiple-block encryption processing and tamper detection.

Also, as one of directions for adding a function to a secret-key block cipher, there is the method of building a tweakable block cipher. A secure tweakable block cipher is a block cipher taking as input what-is-called a “tweak” (or “adjustment value”) in addition to a normal key and a plaintext (or a ciphertext). A tweakable block cipher has a property of, if a tweak is fixed, becoming a normal block cipher and if a tweak is changed even slightly, becoming a completely independent random block cipher without changing the key. Building an efficient tweakable block cipher leads to efficient implementation of functionality for confidentiality and authenticity.

Here, as a construction for implementing a secure tweakable block cipher from a secure block cipher, an LRW construction is known. In an example of the LRW construction, where E (K, M) denotes an encryption function of an original block cipher, an encryption function is defined by

\tilde{E}₀(T,K,M):=E(K,E(K,M)⊕T) [Math. 1].

Here, K is a k-bit secret key and M is an n-bit plaintext. T denotes a tweak and is a bit string of n bits. Also,

⊕ [Math. 2]

is a bitwise exclusive OR. Further, a decryption function is defined by

\tilde{E}₀⁻¹(T,K,C):=E⁻¹(K,E(K,T)⊕C) [Math. 3].

Here, C is a ciphertext.

It is known that the above LRW construction has a periodic property. In other words, where two different plaintexts M, M′ are fixed and a function F is defined as

F(T):=\tilde{E}₀(T,K,M)⊕\tilde{E}₀(T,K,M′) [Math. 4],

F has a period of

s:=E(K,M)⊕E(K,M′) [Math. 5].

In other words,

F(T⊕S)=F(T) [Math. 6]

holds for all of Ts.

Meanwhile, since publication of a research result that a public key cipher such as an RSA, which has currently widely been used, can be broken by a quantum computer, researches for “quantum-resistant public key cipher” ensuring security even after practical quantum computers will have been implemented, has actively been conducted. On the other hand, also in symmetric-key cryptography, a plurality of research results that under a particular situation (for example, a situation in which an encryption circuit is implemented on a quantum computer), a secret-key cryptosystem may be broken in polynomial time, have been reported. Therefore, as with public key cryptosystems, symmetric-key cryptosystems need to ensure quantum-resistant security.

However, since the above LRW construction has a periodic property, it is known that a period s can be calculated in polynomial time by a quantum computer using Simon's period-finding algorithm without a secret key K being known (Non-Patent Literature 1).

### CITATION LIST

### Non-Patent Literature

Non-Patent Literature 1: Marc Kaplan, Gaetan Leurent, Anthony Leverrier, and Maria Naya-Plasencia. Breaking symmetric cryptosystems using quantum period finding. In Advances in Cryptology—CRYPTO 2016-36th Annual International Cryptology Conference, Santa Barbara, Calif., USA, Aug. 14-18, 2016, Proceedings, Part II, pages 207-237, 2016.

### SUMMARY OF THE INVENTION

### Technical Problem

If the value of the period s can be calculated, the value can be used for various attacks against the above LRW construction. Therefore, the above LRW construction can be considered as not ensuring security against a chosen plaintext attack using a quantum computer (that is, not ensuring quantum-resistant security).

An embodiment of the present invention has been made in view of the above points, and an object of the embodiment of the present invention is to provide a tweakable block cipher with ensured quantum-resistant security.

### Means for Solving the Problem

In order to achieve the above object, a cryptographic system according to an embodiment is a cryptographic system including an encryption apparatus that encrypts a plaintext into a ciphertext, the encryption apparatus including: first encryption means for generating first information resulting from encryption of the plaintext by an encryption function of a predetermined block cipher using a first secret key; second encryption means for generating second information resulting from encryption of a preset adjustment value by the encryption function using a second secret key; and third encryption means for generating the ciphertext by encrypting an arithmetic operation result of a bitwise exclusive OR of the first information and the second information via the encryption function using the first secret key.

### Effects of the Invention

A tweakable block cipher with ensured quantum-resistant security can be provided.

### BRIEF DESCRIPTION OF DRAWINGS

FIG. 1 is a diagram illustrating an example of an overall construction of a cryptographic system according to the present embodiment.

FIG. 2 is a flowchart illustrating an example of encryption processing in example 1.

FIG. 3 is a flowchart illustrating an example of decryption processing in example 1.

FIG. 4 is a flowchart illustrating an example of encryption processing in example 2.

FIG. 5 is a flowchart illustrating an example of decryption processing in example 2.

FIG. 6 is a diagram illustrating an example of a hardware construction of a computer.

### DESCRIPTION OF EMBODIMENTS

An embodiment of the present invention will be described below. The present embodiment will be described in terms of a cryptographic system 1 that performs encryption and decryption by a tweakable block cipher with ensured quantum-resistant security.

<Overall Construction>

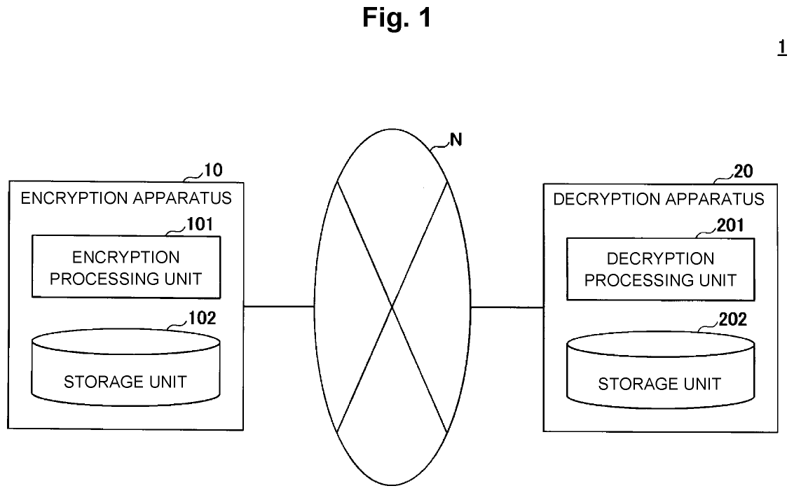

First, an overall construction of the cryptographic system 1 according to the present embodiment will be described with reference to FIG. 1. FIG. 1 is a diagram illustrating an example of the overall construction of the cryptographic system 1 according to the present embodiment.

As illustrated in FIG. 1, the cryptographic system 1 according to the present embodiment includes at least one encryption apparatus 10 and at least one decryption apparatus 20. Also, the encryption apparatus 10 and the decryption apparatus 20 are communicably connected via an arbitrary communication network N, for example, the Internet.

The encryption apparatus 10 is a computer or computer system that encrypts a plaintext by a tweakable block cipher in example 1 or 2, which will be described later. Here, the encryption apparatus 10 includes an encryption processing unit 101 and a storage unit 102.

The encryption processing unit 101 executes encryption processing for encrypting a plaintext by a tweakable block cipher in example 1 or 2, which will be described later. The storage unit 102 stores information necessary for encryption of the plaintext by the tweakable block cipher (for example, the plaintext, a secret key, a tweak, etc.).

The decryption apparatus 20 is a computer or computer system that decrypts a ciphertext by a tweakable block cipher in example 1 or 2, which will be described later. Here, the decryption apparatus 20 includes a decryption processing unit 201 and a storage unit 202.

The decryption processing unit 201 executes decryption processing for decrypting a ciphertext by a tweakable block cipher in example 1 or 2, which will be described later. The storage unit 202 stores information necessary for decryption of the ciphertext by the tweakable block cipher (for example, a ciphertext, a secret key, a tweak, etc.).

### Example 1

In the following, example 1 of the present embodiment will be described.

In the above LRW construction, until a ciphertext C is generated, a plaintext M is encrypted twice by the encryption function E, but a tweak T is encrypted only once by the encryption function E. In general, security becomes higher as the number of times of encryption is larger, and thus, a tweakable block cipher is configured in such a manner that a tweak T is also encrypted twice.

More specifically, an encryption function of a tweakable block cipher in example 1 is defined by expression (1) below.

[Math. 7]

\tilde{E}₁(T,(K,K′),M):=E_{K}(E_{K}(M)⊕E_{K′}(T) (1)

Here, each of K and K′ is a k-bit secret key (that is, a key length of the tweakable block cipher in example 1 is 2 k bits), M is an n-bit plaintext, T denotes a tweak and is a bit string of n bits. Note that it is defined as E_{K}(⋅):=E (K, ⋅) where E is an encryption function of an original block cipher.

Unlike the encryption function for the LRW construction above, the encryption function shown in expression (1) above has no cyclic property. Therefore, the encryption function provides a tweakable block cipher with ensured security against a chosen plaintext attack using a quantum computer (that is, quantum-resistant security is ensured).

Also, a decryption function corresponding to the encryption function shown in expression (1) above is defined by expression (2) below.

[Math. 8]

\tilde{E}₁⁻¹(T,(K,K′),C):=E_{K}⁻¹(E_{K}⁻¹(C)⊕E_{K′}(T)) (2)

Here, C is a ciphertext. Note that E⁻¹ is a decryption function corresponding to the encryption function of the original block cipher (that is, an inverse function of the encryption function of the original block cipher).

Note that generally, when multiple-block encryption, tamper detection (message authentication), and the like are performed, use of a tweakable block cipher enables implementation of a more efficient function than use of a block cipher. Therefore, use of the tweakable block cipher provided by the encryption function shown in expression (1) above and the decryption function shown in expression (2) above enables providing, e.g., more efficient multiple-block encryption and tamper detection (message authentication) while ensuring quantum-resistant security.

### Encryption Processing (Example 1)

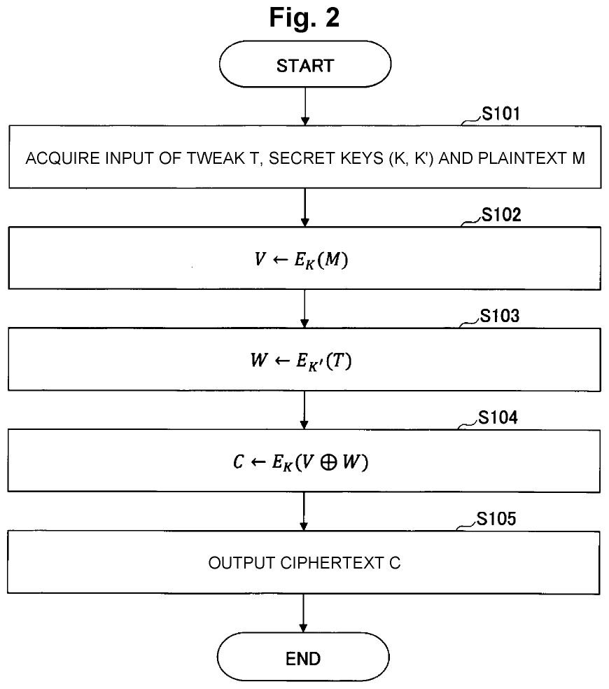

Next, encryption processing in example 1 will be described with reference to FIG. 2. FIG. 2 is a flowchart illustrating an example of encryption processing in example 1.

First, the encryption processing unit 101 acquires an input of the tweak T, the secret keys (K, K′), and a plaintext M stored in the storage unit 102 (step S101).

Next, the encryption processing unit 101 sets V←E_{K}(M) (step S102). In other words, the encryption processing unit 101 encrypts the plaintext M by an encryption function E_{K} and sets the result of the encryption to V.

Next, the encryption processing unit 101 sets W←E_{K′} (T) (step S103). In other words, the encryption processing unit 101 encrypts the tweak T by an encryption function E_{K′} and sets the result of the encryption to W.

Next, the encryption processing unit 101 sets

C←E_{K}(V⊕W) [Math. 9]

(step S104). In other words, the encryption processing unit 101 encrypts a bitwise exclusive OR of V and W by the encryption function E_{K} and sets the result of the encryption to C as a ciphertext.

Then, the encryption processing unit 101 outputs the ciphertext C to any output destination (for example, transmits the ciphertext C to the decryption apparatus 20) (step S105). Consequently, the ciphertext C resulting from encryption by the tweakable block cipher in example 1 is obtained.

<Decryption Processing (Example 1)>

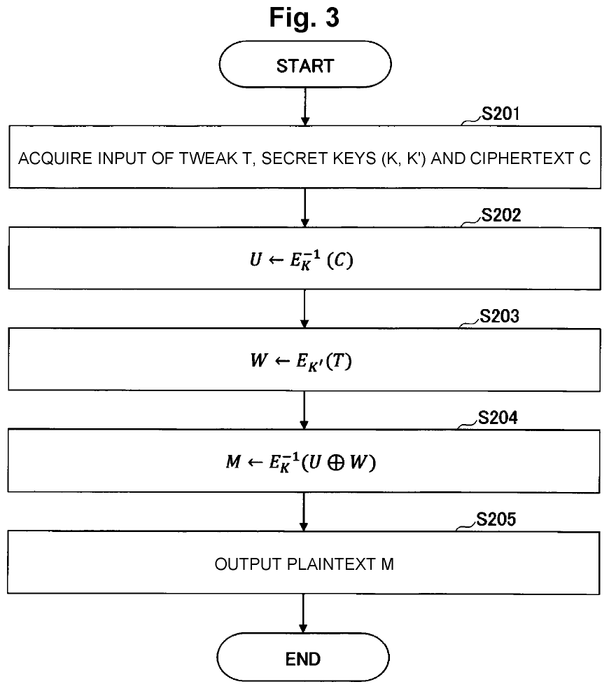

Next, decryption processing in example 1 will be described with reference to FIG. 3. FIG. 3 is a flowchart illustrating an example of decryption processing in example 1.

First, the decryption processing unit 201 acquires an input of the tweak T, the secret keys (K, K′), and the ciphertext C stored in the storage unit 202 (step S201).

Next, the decryption processing unit 201 sets U←E_{K}⁻¹(C) (step S202). In other words, the decryption processing unit 201 decrypts the ciphertext C by a decryption function E_{K}⁻¹ and sets the result of the decryption to U.

Next, the decryption processing unit 201 sets W←E_{K′} (T) (step S203). In other words, the encryption processing unit 101 encrypts the tweak T by the encryption function E_{K′} and sets the result of the encryption to W.

Next, the decryption processing unit 201 sets

[Math. 10]

M←E_{K}⁻¹(U⊕W)

(step S204). In other words, the decryption processing unit 201 decrypts the bitwise exclusive OR of U and W by the decryption function E_{K}⁻¹ and sets the result of the decryption to M as the plaintext.

Then, the decryption processing unit 201 outputs the plaintext M to any output destination (for example, stores the plaintext M in the storage unit 202) (step S205). Consequently, the ciphertext C resulting from encryption by the tweakable block cipher in example 1 is decrypted as the plaintext M.

### Example 2

In the following, example 2 of the present embodiment will be described.

Although in the tweakable block cipher in the example 1 above, the secret keys (K, K′) are used, in example 2, a tweakable block cipher using secret keys (K, K′, K″) is configured because security is generally enhanced more as the number of secret keys is larger (as the bit length of secret keys is longer). Consequently, security that is higher than that of the tweakable block cipher in example 1 can be provided.

More specifically, an encryption function of the tweakable block cipher in example 2 is defined by expression (3) below.

[Math. 11]

É₂(K,K′,K″),M):=E_{K″}(E_{K}(M)⊕E_{K′}(T)) (3)

Also, a decryption function corresponding to the encryption function shown in expression (3) above is defined by expression (4) below.

[Math. 12]

\tilde{E}₂⁻¹(T,(K,K′,K″),C):=E_{K}⁻¹(E_{K″}⁻¹(C)⊕E_{K′}(T)) (4)

As in example 1, use of the tweakable block cipher implemented by the encryption function shown in expression (3) above and the decryption function shown in expression (4) above enables implementation of more efficient multiple-block encryption, tamper detection (message authentication), and the like while ensuring quantum-resistant security.

<Encryption Processing (Example 2)>

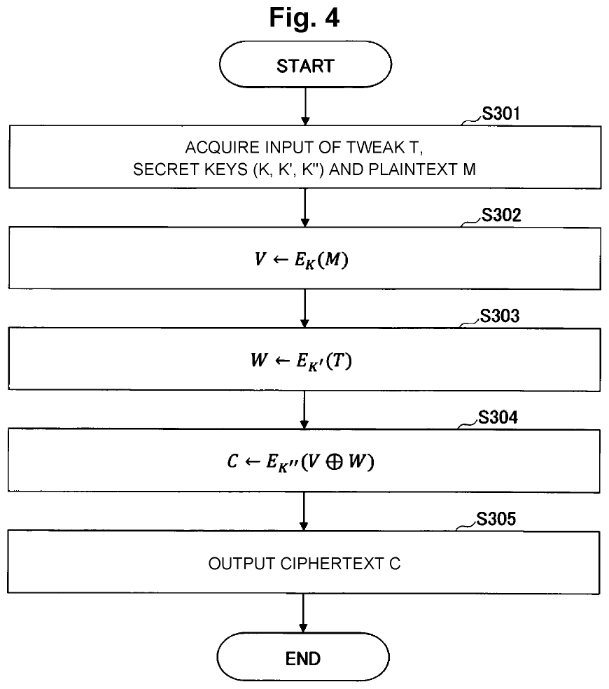

Next, encryption processing in example 2 will be described with reference to FIG. 4. FIG. 4 is a flowchart illustrating an example of encryption processing in example 2.

First, the encryption processing unit 101 acquires an input of the tweak T, the secret keys (K, K′, K″), and a plaintext M stored in the storage unit 102 (step S301).

Next, the encryption processing unit 101 sets V←E_{K}(M) (step S302). In other words, the encryption processing unit 101 encrypts the plaintext M by the encryption function E_{K} and sets the result of the encryption to V.

Next, the encryption processing unit 101 sets W←E_{K′}(T) (step S303). In other words, the encryption processing unit 101 encrypts the tweak T by the encryption function E_{K′} and sets the result of the encryption to W.

Next, the encryption processing unit 101 sets

[Math. 13]

C←E_{K″}(V⊕W)

(step S304). In other words, the encryption processing unit 101 encrypts a bitwise exclusive OR of V and W by the encryption function E_{K} and sets the result of the encryption to C as a ciphertext.

Then, the encryption processing unit 101 outputs the ciphertext C to any output destination (for example, transmits the ciphertext C to the decryption apparatus 20) (step S305). Consequently, the ciphertext C resulting from encryption by the tweakable block cipher in example 2 is obtained.

<Decryption Processing (Example 2)>

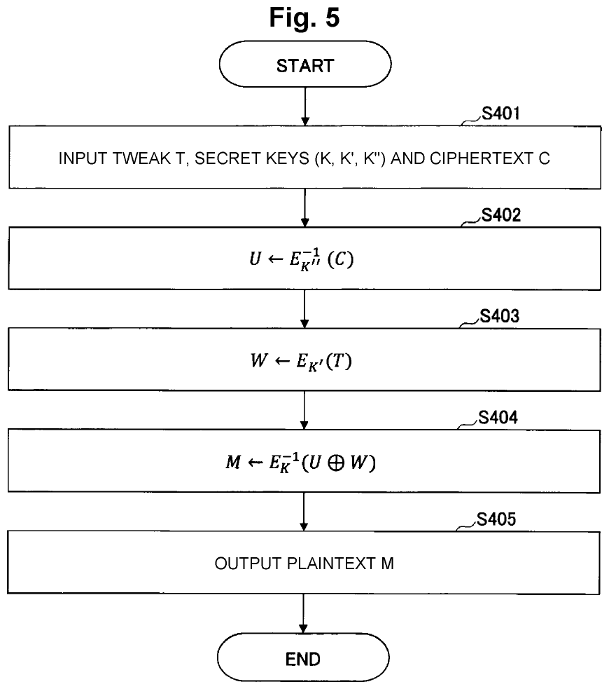

Next, decryption processing in example 2 will be described with reference to FIG. 5. FIG. 5 is a flowchart illustrating an example of decryption processing in example 2.

First, the decryption processing unit 201 acquires an input of the tweak T, the secret keys (K, K′, K″) and the ciphertext C stored in the storage unit 202 (step S401).

Next, the decryption processing unit 201 sets U←E_{K″}⁻¹(C) (step S402). In other words, the decryption processing unit 201 decrypts the ciphertext C by a decryption function E_{K″}⁻¹ and sets the result of the decryption to U.

Next, the decryption processing unit 201 sets W←E_{K′} (T) (step S403). In other words, the encryption processing unit 101 encrypts the tweak T by the encryption function E_{K′} and sets the result of the encryption as W.

Next, the decryption processing unit 201 sets

M←E_{K}⁻¹(U⊕W) [Math. 14]

(step S404). In other words, the decryption processing unit 201 decrypts the bitwise exclusive OR of U and W by the decryption function E_{K}⁻¹ and sets the result of the decryption to M as the plaintext.

Then, the decryption processing unit 201 outputs the plaintext M to any output destination (for example, stores the plaintext M in the storage unit 202) (step S405). Consequently, the ciphertext C resulting from encryption by the tweakable block cipher in example 2 is decrypted as the plaintext M.

<Hardware Construction>

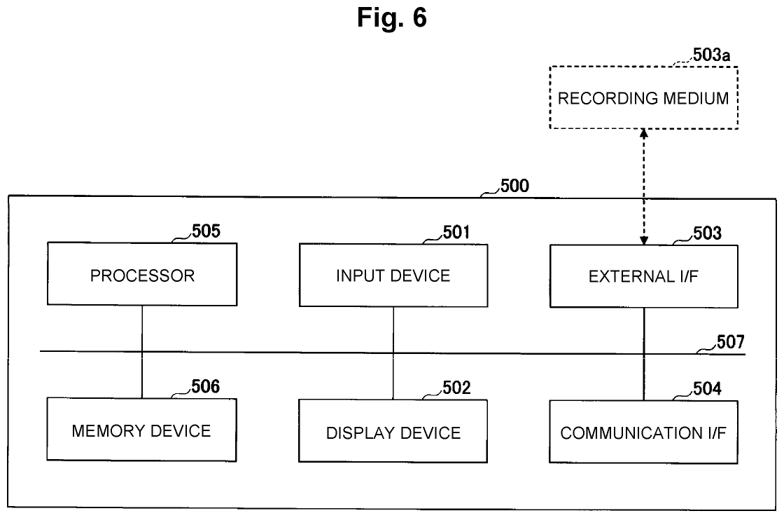

Lastly, a hardware construction of the encryption apparatus 10 and the decryption apparatus 20 included in the cryptographic system 1 according to the present embodiment will be described. The encryption apparatus 10 and the decryption apparatus 20 can be implemented, for example, by a hardware construction of a computer 500 as illustrated in FIG. 6. FIG. 6 is a diagram illustrating an example of the hardware construction of the computer 500.

The computer 500 illustrated in FIG. 6 includes an input device 501, a display device 502, an external I/F 503, a communication I/F 504, a processor 505 and a memory device 506. These hardware components are communicably connected via a bus 507.

The input device 501 includes, for example, a keyboard, a mouse and/or a touch panel. The display device 502 is, for example, a display. Note that the computer 500 may or may not have at least one of the input device 501 and the display device 502.

The external I/F 503 is an interface with an external device. Examples of the external device include a recording medium 503a and the like. The computer 500 can perform operations such as reading and writing to/from the recording medium 503a via the external I/F 503. On the recording medium 503a, one or more programs that implement the encryption processing unit 101 may be stored, and one or more programs that implement the decryption processing unit 201 may be stored.

Note that the recording medium 503a includes, e.g., a CD (compact disc), a DVD (digital versatile disc), an SD memory card (Secure Digital memory card), and a USB (Universal Serial Bus) memory card.

The communication I/F 504 is an interface for connecting the computer 500 to a communication network. Note that the one or more programs that implement the encryption processing unit 101, and the one or more programs that implement the decryption processing unit 201 may be acquired (downloaded) from a predetermined server apparatus or the like via the communication I/F 504.

The processor 505 includes, for example, various arithmetic devices such as a CPU (central processing unit) and a GPU (graphics processing unit). The encryption processing unit 101 is implemented by, for example, processing that the one or more programs stored in the memory device 506 causes the processor 505 to execute. Likewise, the decryption processing unit 201 is implemented by, for example, processing that the one or more programs stored in the memory device 506 causes the processor 505 to execute.

The memory device 506 includes various storage devices such as an HDD (hard disk drive), an SSD (solid-state drive), a RAM (random access memory), a ROM (read-only memory), and a flash memory. The storage unit 102 and the storage unit 202 can be implemented, for example, using the memory device 506.

The encryption apparatus 10 included in the cryptographic system 1 according to the present embodiment can implement the above-described encryption processing by including the hardware construction of the computer 500 illustrated in FIG. 6. Likewise, the decryption apparatus 20 included in the cryptographic system 1 according to the present embodiment can implement the above-described decryption processing by including the hardware construction of the computer 500 illustrated in FIG. 6. Note that the hardware construction of the computer 500 illustrated in FIG. 6 is an example and the computer 500 may have a different hardware construction. For example, the computer 500 may include a plurality of processors 505 or may include a plurality of memory devices 506.

The present invention is not limited to the above embodiment that has specifically been disclosed, and various alternations and changes, combinations with known techniques, and the like are possible without departing from the description of the claims.

### REFERENCE SIGNS LIST

1 cryptographic system
10 encryption apparatus
20 decryption apparatus
101 encryption processing unit
102 storage unit
201 decryption processing unit
202 storage unit

1. A cryptographic system comprising:
an encryption apparatus including a memory and a processor configured to encrypt a plaintext into a ciphertext,
wherein the processor of the encryption apparatus executes:
generating first information resulting from encryption of the plaintext by an encryption function of a predetermined block cipher using a first secret key;
generating second information resulting from encryption of a preset adjustment value by the encryption function using a second secret key; and
generating the ciphertext by encrypting an arithmetic operation result of a bitwise exclusive OR of the first information and the second information by the encryption function using the first secret key.

2. The cryptographic system according to claim 1, further comprising:
a decryption apparatus including a memory and a processor configured to decrypt the ciphertext, the decryption apparatus executes:
generating third information resulting from decryption of the ciphertext by a decryption function using the first secret key, the decryption function corresponding to the encryption function;
generating the second information resulting from encryption of the adjustment value by the encryption function using the second secret key; and
for generating the plaintext by decrypting the arithmetic operation result of the bitwise exclusive OR of the third information and the second information by the decryption function using the first secret key.

3. The cryptographic system according to claim 2, wherein
the generating of the ciphertext is executed by encrypting the arithmetic operation result of the bitwise exclusive OR of the first information and the second information by the encryption function using a third secret key instead of the first secret key; and
the generating of the third information results from decryption of the ciphertext by the decryption function using the third secret key instead of the first secret key.

4. An encryption method executed by an encryption apparatus including a memory and a processor configured to encrypt a plaintext into a ciphertext, the encryption method comprising:
generating first information resulting from encryption of the plaintext by an encryption function of a predetermined block cipher using a first secret key;
generating second information resulting from encryption of a preset adjustment value by the encryption function using a second secret key; and
generating the ciphertext by encrypting an arithmetic operation result of a bitwise exclusive OR of the first information and the second information by the encryption function using the first secret key.

5. A decryption method executed by a decryption apparatus including a memory and a processor configured to decrypt a ciphertext resulting from encryption of a plaintext by an encryption apparatus, the decryption method comprising:
generating third information resulting from decryption of the ciphertext by a decryption function using a first secret key, the decryption function corresponding to an encryption function of a predetermined block cipher;
generating second information resulting from encryption of the preset adjustment value by the encryption function using a second secret key; and
generating the plaintext by decrypting the arithmetic operation result of the bitwise exclusive OR of the third information and the second information by the decryption function using the first secret key.

6. A non-transitory computer-readable recording medium having computer-readable instructions stored thereon, which when executed, cause a computer including a memory and a processor to execute the generating of the first information, the generating of the second information, and the generating of the ciphertext in the encryption apparatus included in the cryptographic system according to claim 1.
